(19) United States
(12) Patent Application Publication
(10) Pub. No.: US 2008/0133402 A1
(43) Pub. Date: Jun. 5, 2008

(54) SOCIOFINANCIAL SYSTEMS AND METHODS

(76) Inventors: Kerry Ivan Kurian, Cambridge, MA (US); Paras Patel, Belmont, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/850,610

(22) Filed: Sep. 5, 2007

Related U.S. Application Data
(60) Provisional application No. 60/842,307, filed on Sep. 5, 2006.

(51) Int. Cl. G06Q 40/00

(52) U.S. Cl. 705/38

(57) ABSTRACT

Embodiments of the present invention provide improved ways for lenders, creditors, and intermediaries to extend credit to borrowers, debtors, and intermediaries. A sociofinancial graph that encodes financial trust relationships between lenders, creditors, borrower, debtors, and intermediaries. Social networking websites can be used to construct the sociofinancial graph, with or without the use of credit scores.

### CROSS-REFERENCE TO RELATED APPLICATIONS

This application claims the benefit of the following provisional application that is hereby incorporated by reference in its entirety:

U.S. Provisional App. No. 60/842,307, filed Sep. 5, 2006.

### BACKGROUND

1. Field:

The present invention relates to the field of money lending and, in particular, to systems and methods for borrowing and lending in association with online social network.

2. Description of Related Art

Lenders (including peers, financial institutions, merchants, and the like) in the more developed areas the world typically use a credit score as a measure of an individual's or entity's creditworthiness. Roughly speaking, a credit score categorizes or assigns a probability to the likelihood that an individual or entity will honor a debt.

Credit scores were developed to accommodate merchants and banks that needed to extend credit to individuals and entities that were not personally known to them.

Credit scores are a relatively recent phenomenon in the history of credit. For centuries if not millennia before the emergence of credit scores, lending decisions were made on the basis of trust relationships and codes of conduct between individuals or groups within communities. In many offline communities, and especially in offline communities that are in less developed areas of the world, this is still the predominant form of lending.

Recently, online communities such as Facebook have emerged. A major function of online communities is to capture and encode relationships between people, groups of people, entities, groups of entities, and so on. Based upon these relationships, it is possible for members of the online community to share applications and content with one another. Also, in some cases it is possible for computing applications to access these encoded relationships and use them for some purpose.

There exists a need to capture and encode financial trust relationships in online communities, and to enable borrowing, lending, repayment, collections, and related actions based upon such relationships.

### SUMMARY

Applications of a sociofinancial graph may be associated with actions that are related to borrowing and lending. These actions may without limitation include expressing or granting a trust relationship, accepting or receiving a trust relationship, enabling or disabling a trust relationship, instantiating or revoking a trust relationship, calculating a possible lending action based upon a trust relationship, executing a lending action based upon a trust relationship, extending credit based upon a trust relationship, associating a legal right or obligation with a trust relationship, transmitting a communication that pertains to a trust relationship and/or a debt that is associated with a trust relationship, repaying a debt that is associated with a trust relationship, collecting on a debt that is associated with a trust relationship, and so on.

In embodiments, a receiver or grantor of trust may utilize a web interface on a client in order to take actions that are attributed to or associated with the receiver or grantor. In embodiments, a receiver or grantor may utilize a web interface on a client in order to configure an automatic process for taking actions that are attributed to or associated with the receiver or grantor. In embodiments, an automatic process that is instantiated with default settings may effect any and all of the actions that are attributed to or associated with the receiver or grantor.

In embodiments, the trust relationship may be associated with one or more states that indicate whether or not the relationship is active, in what circumstances and/or on what terms the relationship may be utilized or relied upon, and so on.

In embodiments, the receiver may issue to the grantor a request for the trust relationship. In embodiments, the grantor may provide the trust relationship to the receiver in response to such a request. In embodiments, the grantor may provide the trust relationship irrespective of whether there is such a request from the receiver.

In embodiments, the trust relationship may be automatically instantiated, activated, or otherwise enabled upon provision by the grantor. In embodiments, the trust relationship may be instantiated, activated, or otherwise enabled only after both the grantor has provided and the receiver has approved the trust relationship. The receiver may approve the trust relationship by opting into the relationship. The grantor may disapprove of the trust relationship by refusing or opting out of the relationship.

In embodiments, the grantor may issue to the receiver a pre-approval of a trust relationship. In such embodiments, the receiver may respond to the pre-approval by transmitting a signal or other information back to the grantor. Then, in response to the signal, the grantor may enable, activate, grant, or otherwise approve the trust relationship.

In embodiments, the grantor may revoke, disable, invalidate, remove, or otherwise make unavailable or inoperable one or more trust relationships that it provided, enabled, activated, granted or otherwise approved. In embodiments, the receiver may revoke, disable, invalidate, remove, opt out of, or otherwise make unavailable or inoperable one or more trust relationship that it previously received, accepted, was granted, or with which it otherwise became associated.

In embodiments, the grantor may re-enable or otherwise again make available or operable a trust relationship that it previously made unavailable or inoperable. In embodiments, the receiver may re-enable or otherwise again make available a trust relationship that it previously made unavailable or inoperable.

In embodiments, the financial trust relationship may be associated with a legal and/or financial agreement. For example and without limitation, the agreement may specify that, in the event that the receiver defaults on a debt, the grantor must honor all or part of that debt, up to a specified monetary limit that may or may not be finite. The agreement may specify that, in the event that a debt is issued to the receiver, the grantor may receive one or more payments or other forms of compensation in association with the debt.

In embodiments, a debt collections action may be more or less automatically initiated upon a delinquency or default. The debt collections action may without limitation include engaging a debt collections agency, transmitting a message to the delinquent or defaulter, transmitting a message to individuals or entities that have a direct trust relationship with the delinquent or defaulter, transmitting a message to individuals or entities that have an indirect trust relationship with the delinquent or defaulter, transmitting a message to the creditor, and so on.

In embodiments, a single lender may invoke or rely upon one or more trust relationships in the course of issuing credit to a single borrower. In embodiments, a plurality of lenders may invoke or rely upon one or more trust relationships in the course of issuing credit to a single borrower.

In embodiments, a lender or creditor may be a lending institution such as and without limitation a bank. In embodiments, a lender or creditor may be an individual or member of an online community. In embodiments, a borrower or debtor may be an institution such as and without limitation a corporation. In embodiments, a borrower or debtor may be an individual or member of an online community. In embodiments the lender or creditor may or may not be a member of the online community.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a sociofinancial facility.

FIG. 2 depicts a logical flow diagram of a registration process.

FIG. 3 depicts a logical flow diagram of a credit calculation process.

FIG. 4 depicts a logical flow diagram of a process for finding a funding path in a sociofinancial graph.

FIG. 5 depicts a logical flow diagram of a process for using trust relationships in association with a request for credit.

FIG. 6 depicts a logical flow diagram for a process for approving a lending action.

FIG. 7 is intentionally omitted.

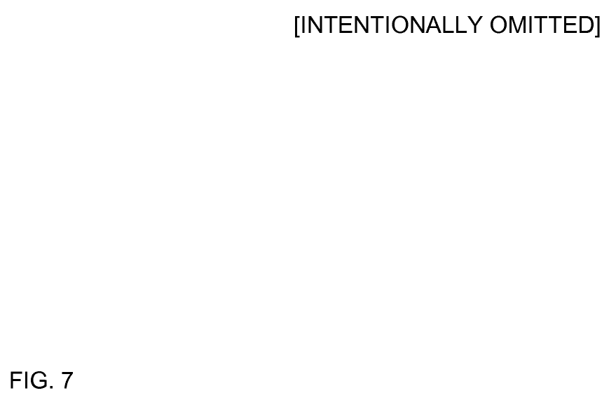

FIG. 8 depicts a function that returns the weight between two vectors.

FIG. 9 is intentionally omitted.

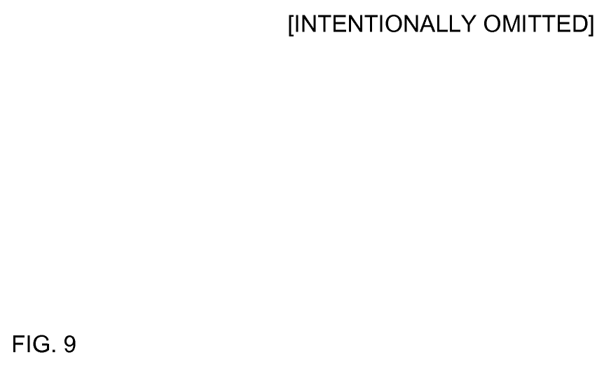

FIG. 10 depicts an embodiment in which credit scores are utilized by a traditional lending facility.

FIG. 11 depicts a data structure for encoding operational data.

FIG. 12 depicts function flow function ƒ and weight function w.

FIG. 13 depicts an interactive process for making a determination.

FIG. 14 depicts a logical flow diagram of a process for initializing data structures.

FIG. 15 depicts a logical flow diagram of a process for pre-approving a request for credit.

FIG. 16 depicts a logical flow diagram of a process for approving the use of trust relationships in association with a request for credit.

### DETAILED DESCRIPTION

Systems and methods of the present invention may capture, encode, and utilize a sociofinancial graph to enable or improve decision making that is associated various lending actions. These lending actions may, without limitation, include setting the terms of a loan offer, making a loan offer, funding a loan, making a loan, authorizing a credit transaction, extending credit, determining a credit limit, and so on. In embodiments, the present invention may enable near-instant decision making for a lending action. More generally, an explicit model of financial trust relationships can facilitate faster, more accurate lending decisions and support more complex lending and guarantee transactions.

A bank or credit card company can use the sociofinancial graph to calculate whether and how much credit to extend to an individual or entity. An individual can use the sociofinancial graph to evaluate whether and how much credit to extend to a peer. An individual or entity can use the sociofinancial graph to express its willingness to co-sign, guarantee, or otherwise back a debt of another individual or entity. A lender or creditor can use the sociofinancial graph to diversify and/or reduce the risk of experiencing a default by engaging individuals or entities that are represented in the sociofinancial graph to co-sign, guarantee, or otherwise back all or part of a debt. An individual or entity can use the sociofinancial graph to receive a payment or other consideration in exchange for co-signing, guaranteeing, or otherwise backing all or part of a debt. Many other uses of the sociofinancial graph will be appreciated and all such uses are within the scope of the present disclosure.

Throughout this disclosure, the terms “individual” and “entity” may be used interchangeably to refer to a person, a group of people, a group of people formed through some form of affinity, a company, a group of companies, a legal entity, a group, a clan, and so on. Furthermore, it will be appreciated that a “lender” may be any entity that is capable of lending, such as and without limitation an individual, a group of individuals, a group of individuals formed through some form of affinity, a company, a group of companies, a legal entity, and so on. Still further, it will be appreciated that a “borrower” may be any entity that is capable of borrowing, such as and without limitation an individual, a group of individuals, a group of individuals formed through some form of affinity, a company, a group of companies, a legal entity, and so on.

Throughout this disclosure, the words “debt” and “loan” may be used interchangeably to refer to a sum of money that is lent and that is to be paid back with or without interest. Furthermore, the words “lender” and “creditor” may be used interchangeably to indicate an entity to which a sum of money is owed. Still further, the words “borrower” and “debtor” may be used interchangeably to indicate an entity that owes a sum of money.

Applications of the sociofinancial graph have advantages have that will be appreciated from a mathematical perspective. In particular, it will be appreciated that, so long as some entities that are associated with a debt have a probability of default that is less than 1.0, the probability of a creditor's exposure to a default approaches zero as a function of both an increasing number of entities associated with a loan transaction and an increasing degree of separation between the creditor and the debtor through the sociofinancial graph.

Applications of the sociofinancial graph have advantages that will be appreciated from a social or business perspective. In particular, it will be appreciated that when entities express financial trust in a debtor those entities may exert pressure upon the debtor to repay a debt. This may be due to financial responsibilities that the entities would have to a creditor if the debtor were to default. In practice, this pressure may reduce the creditor's risk of being exposed to a default.

In embodiments, any and all number of entities may express financial trust in one another and so the sociofinancial graph may embody a graph of financial trust between entities. It will be appreciated that the sociofinancial graph may support any number of degrees of separation between the creditor and the debtor.

In general, a computer-implemented financial trust network is described below as a flow network including vertices that represent participating entities and edges that represent explicit trust relationships between entities. While this characterization is useful for describing a number of techniques for creating and evaluating such networks, it will be appreciated that numerous variations and enhancements are possible. For example, an aggregate statistic such as a credit score may be added to the flow network by representing the credit score agency as a participant and representing the credit score as a willingness of the participant to collateralize debt. Even where this particular entity is not asked or expected to co-sign or otherwise guarantee a loan, the information contained in the credit score may be usefully integrated into a loan decision supported by the network. In another aspect, a lender may employ information external to the flow network to refine a network-based lending decision in a supplemental process. Thus it will be understood that the detailed description below does not exclude a flexible use of the flow network where certain vertices and edges model non-participant information, nor does the description exclude the consideration of additional information outside the flow network in a particular lending decision. All such variations as would be clear to one of ordinary skill in the art are intended to fall within the scope of this disclosure.

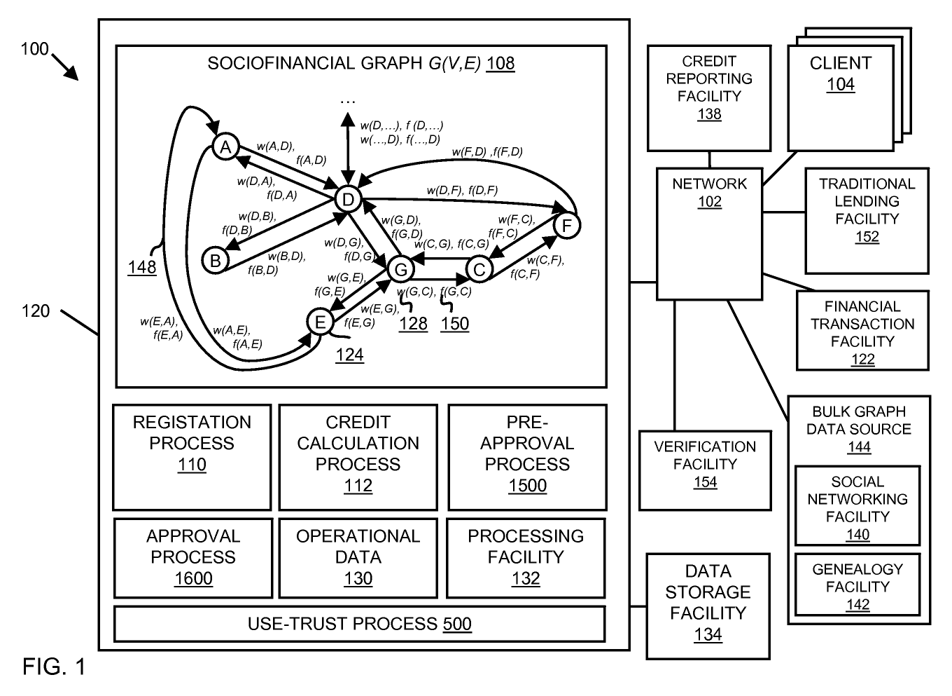

Referring to FIG. 1, an embodiment of a sociofinancial facility 100 may comprise a network 102, one or more clients 104, a traditional lending facility 152, a verification facility 154, a registration process 110, a credit calculation process 112, a sociofinancial computing facility 120, a financial transaction facility 122, one or more vertices 124, one or more weights 128, operational data 130, a processing facility 132, a data storage facility 134, a credit reporting facility 138, a social networking facility 140, a genealogy facility 142, a bulk graph data source 144, one or more edges 148, one or more flow functions 150, and so on. The sociofinancial computing facility 120 may comprise the sociofinancial graph 108, the registration process 110, the credit calculation process 112, the operational data 130, the processing facility 132, and so on. The sociofinancial graph 108 may comprise the vertices 124, the weights 128, the edges 148, the flow functions 150, and so on.

The sociofinancial computing facility 120 may comprise one or more processing facilities 132. In embodiments, a processing facility 132 may comprise server computers, themselves comprising CPUs, a memory device, network ports, power ports, and the like. The memory device may comprise random access memory, a tape drive, a hard drive, and so on. The server computers may encompass rack-mount servers, tower servers, blade servers, super computers, video game consoles or special-purpose computers, and so on. The server computers may be arranged in a standalone, cluster, failover, redundant, distributed, or other configuration. In any case, the sociofinancial computing facility 120 may be operatively coupled to the network 102. This operative coupling may provide data communications, such as and without limitation TCP/IP communications, SMS communications, MMS communications, voice communications, and so on. It will be appreciated that any and all of the processes described herein may be carried out by software running on the processing facility 120.

The network 102 may comprise a packet data network, a circuit-switched network, an Internet Protocol (IP) network, a cellular telephone network, and so on. In embodiments, the network 102 may comprise the Internet.

The client 104 may comprise a personal computer, a personal digital assistant, a cell phone, a pager, a kiosk, an ATM, any and all combinations of the foregoing, and so on. The client 104 may comprise a user interface for providing information to a user and receiving information from a user. The client 104 may be operatively coupled to the network 102. This operative coupling may provide data communications, which may be associated with the data communications between the network 102 and the sociofinancial computing facility 120. In this way, the client 104 may be in communication with the sociofinancial computing facility 120.

The financial transaction facility 122 may comprise a computing facility or any and all other automatic or manual facilities for processing a financial transaction. The financial transaction facility 122 may be associated with a bank, a lending or borrowing institution, a mutual fund company, a financial brokerage, a peer-to-peer money transfer facility (such as and without limitation PayPal), and so on. The financial transaction facility 122 may be operatively coupled to the network. This operative coupling may provide data communications, which may be associated with the data communications between the sociofinancial computing facility 120 and the network 102. In this way, the financial transaction facility 122 may be in communication with the sociofinancial computing facility 120. This communication may, without limitation, convey information pertaining to an account balance, a financial transfer, a loan, a loan repayment, a default, and so on.

The credit reporting facility 138 may comprise a computing facility or any and all other automatic or manual facilities for providing a credit report and/or processing information that is associated with a credit report. The credit reporting facility 138 may be associated with a credit reporting agency or the like. The credit reporting facility 138 may be operatively coupled to the network 102. This operative coupling may provide data communications, which may be associated with the data communications between the sociofinancial computing facility 120 and the network 102. In this way, the credit reporting facility 138 may be in communication with the sociofinancial computing facility 120. This communication, without limitation, may convey information pertaining to a credit report, credit score, an on-time loan payment, a late loan payment, a loan, a default, and so on.

The data storage facility 134 may comprise a hard drive, a RAID, or any and all other kinds of data storage device. The data storage facility 134 may comprise a central processing unit, a storage-oriented processing unit, and so on. The data storage facility 134 may provide redundancy, failover, backup, recovery, et cetera with respect to storing data. The data storage facility 134 may be operatively coupled to the sociofinancial computing facility 120. This operative coupling may provide data communications. In embodiments, the operative coupling may comprise an Ethernet connection, a Fibre Channel connection, and the like.

The bulk graph data source 144 may comprise a computing facility encompassing data that may be used, in whole or in part, to construct some of or the entire sociofinancial graph 108. This data may relate to an individual or group, a relationship or association between an individual or group, a level of trust that is associated with the relationship or association, a financial commitment that is associated with the relationship, a validation or rebuttal of the relationship, and so on.

The bulk graph data source 144 may comprise a social networking facility 140, which may provide some or all of the data that the bulk graph data source 144 encompasses. In embodiments, the social networking facility 140 may comprise a web-based social network. Generally, a social network (web-based or otherwise) may comprise a set of individuals and/or organizations and a set of affiliations between some or all of the individuals and/or organizations. Such affiliations may exist between individuals and individuals, individuals and organizations, organizations and organizations, and the like. The nature of these affiliations may be described in greater detail hereinafter with reference to the sociofinancial graph 108.

The bulk graph data source 144 may comprise a genealogy facility 142, which may provide some or all of the data that the bulk graph data source 144 encompasses. In embodiments, the genealogy facility 142 may comprise a web-based family tree. Generally, a family tree (web-based or otherwise) may comprise a graph data structure with vertices representing individuals and edges representing parent/offspring relationships, marriage relationships, and so forth. Each edge may be labeled to indicate the direct relationship between the two individuals that are connected by the edge. Thus, by traversing the graph, it may be possible to determine any individual's familial relationship to any other individual so long as there is a path through the graph between those individuals.

The sociofinancial computing facility 120 may extract or receive the data from the bulk graph data source 114; transform the bulk graph data into a sociofinancial graph 108; import the bulk graph data into a sociofinancial graph 108; load the data in its raw, transformed, or imported form into the data storage facility 134; and so on

The traditional lending facility 152 may comprise or be associated with a bank or other lending institution. The traditional lending facility 152 may comprise a computing facility that is operatively coupled to the network 102. The traditional lending facility may participate in a communication with the sociofinancial computing facility 120, wherein the communication comprises the transmission of one or more signals. This communication may enable various lending actions on behalf of the bank or other lending institution, wherein the lending actions are associated with or rely upon financial trust between entities that are encoded in the sociofinancial graph 108.

The verification facility 154 may comprise or be associated with a trusted third-party authority that verifies the identity of entities, verifies the authenticity of signals, and so on. Numerous encryption-based commercial services exist for providing authentication of identity by a trusted third party, such as provided by VeriSign or Entrust, and may be suitably employed as the verification facility 154 described herein. The verification facility 154 may also, or instead, operate as an independent certificate authority using, for example and without limitation, certificates from a free public provider (such as CAcert.org, Thawte, or the like) or a wholly independent certificate authority platform. In embodiments, the verification facility 154 may comprise a computing facility that is operatively coupled to the network 102. Any and all steps in the processes described herein may function on the condition that the entities or signals that are associated with the processes have been verified by the verification facility 154. The verification facility 154 may communicate with the sociofinancial computing facility 120 via signals. These signals may include signals requesting a verification, confirming a verification, denying a verification, and so on. In embodiments, the verification facility 154 may comprise a certificate authority or web of trust and the signals may comprise cryptographically signed data. In embodiments, any and all elements of the sociofinancial facility may verify the authenticity of signals by checking a cryptographic signature on the signals, wherein the cryptographic signature is associated with or enabled by the verification facility 154. In embodiments, any and all elements of the sociofinancial facility may create authenticated signals by signing them with a cryptographic signature that is associated with or enabled by the verification facility 154. In embodiments, the sociofinancial computing facility 120 may comprise an interface to the verification facility 154 for verifying the identity of an entity, the authenticity of a signal, and so on.

The sociofinancial graph 108 G(V,E) may encompass a weighted flow network comprising a set of vertices 124 V and a set of directed edges 148 E. Between any two vertices u and v in V there may exist in E no directed edges 148, one directed edge 148 that is (u,v) or (v,u), or two directed edges 148 that are (u,v) and (v,u). While a weighted flow network is one useful embodiment of a graph for encoding financial trust networks, it will be understood that a number of other graph-based and other techniques may be suitably employed for modeling a collection of financial trust relationships. For example, the graph 108 may be an unweighted flow network (or simply, a flow network), a weighted directed graph, a directed graph, and an undirected graph. In certain embodiments, one graph type may be employed to express other graph types. By way of example, the weighted flow network may be employed to express other graph types. Where the weight function 128 w produces a constant for all edges 148, the weight function 128 w may be omitted and the sociofinancial graph 108 forms a flow network (as opposed to a weighted flow network). Where the flow function 150 ƒ produces a constant for all edges 148, the flow function 150 ƒ may be omitted and the sociofinancial graph 108 forms a weighted directed graph (as opposed to some kind of flow network). It will be appreciated that there may be cases where both the flow function 150 ƒ and the weight function 128 w can be omitted. In these cases the sociofinancial graph 108 forms a directed graph (as opposed to a weighted directed graph or some kind of flow network). It will be appreciated that there may be cases where both the flow function 150 ƒ and the weight function 128 w can be omitted, and where all edges 148 exist in equal and opposite pairs. In these cases the sociofinancial graph 108 forms an undirected graph. The sociofinancial graph 108 may comprise gains such that, if an edge has a gain g and an amount x flows into the edge at its tail, then an amount gx flows out at its head. Therefore, in consideration of the foregoing, the phrase “weighted flow network” should be interpreted broadly as “weighted flow network; and, according to the optimization where the weight function is omitted, flow network; and, according to the optimization where the flow function is omitted, weighted directed graph; and, according to the optimization where both the flow function and weight function are omitted, directed graph; and, according to the optimization where both the flow function and weight function are omitted and all edges exist in equal and opposite pairs, undirected graph; wherein the flow network or weighted flow network may include gains”.

Still more generally, numerous other techniques may be employed to model financial trust relationships. All such techniques as would be apparent to one of ordinary skill in the art are intended to fall within the scope of this disclosure.

Each vertex 124 may represent or be associated with an entity. Each edge 148 between two vertices 124 may encode a financial trust relationship between such entities. When two vertices 124 are connected by an edge, the entities that are represented by or associated with the vertices 124 can be said to have a direct financial trust relationship. When there exists a path in the sociofinancial graph 108 from one vertex 124 to another and, at the same time, there does not exist an edge 148 that directly connects the two vertices 124, then the entities that are represented by or associated with the vertices 124 can be said to have an indirect financial trust relationship.

In embodiments, the financial trust relationship may be associated with one or more types of affiliation between entities. For example and without limitation, an affiliation may be an individual pilot's membership in an aircraft owners and pilots association; an alumni's affinity for his alma mater; an attorney-client relationship between a law firm and a client company; a familial relationship between a father and a son; a friendship between two individuals; a working relationship between two individuals; an association between two individuals as represented by an online social network; a combination of relationships between two entities (for example and without limitation, two individuals may share both a friendship and a familial relationship, and so on); and so forth. In embodiments and without limitation, an affiliation may represent that one entity is personally known to the other entity; that one entity has an affinity for another entity; that one entity has an allegiance to another entity; that one entity is a member of another entity; and so on. Many such examples of affiliations and entities will be appreciated and all such examples are within the scope of the present disclosure.

The vertex 124 at the tail of an edge 148 may be referred to as the “source vertex” and the vertex 124 at the head of the edge 148 may be referred to as the “destination vertex.” The entity that may be associated with the source vertex is the one that grants, approves, authorizes, or otherwise instantiates the trust relationship. Generally, this entity may be referred to herein and elsewhere as the “grantor.” The entity that may be associated with the destination vertex is the one that receives, accepts, or is otherwise granted the trust relationship. Generally, this entity may be referred to herein and elsewhere as the “receiver.”

The depicted sociofinancial graph 108 is provided for the purpose of illustration and not limitation and shows seven vertices 124 that are labeled A through F plus some number of additional vertices 124 that are implied by the ellipsis. In embodiments, the sociofinancial graph 108 may contain any number of vertices 124.

The sociofinancial computing facility 120 may create and/or maintain the sociofinancial graph 108. Without limitation, this creation and/or maintenance may be conducted in accordance with one or more processes of the socioeconomic computing facility 120, including the registration process 110, the credit calculation process 112, and so on.

From time to time, any vertex 124 may be associated with an entity that is acting as a borrower, a lender, a debtor, a creditor, an intermediary (such as and without limitation a co-signer or guarantor), and so on. When associated with a borrower or debtor, the vertex 124 may be denoted b. When associated with a lender or creditor, the vertex 124 may be denoted 1. When associated with an intermediary (that is, an entity that is neither the borrower/debtor nor the lender/creditor but that resides on a path between the borrower/debtor and the lender/creditor), the vertex 124 may be denoted i. A lender may serve as a source of funds in the weighted flow network G(V,E) 108. A borrower may serve as a sink of funds in the flow network G(V,E) 108. When determining the credit limit for a borrower/debtor, the sociofinancial computing facility 120 may calculate a flow along one or more paths through G(V,E) from l to b. The intermediary may reside along one or more of those paths.

In embodiments, the intermediary may serve as a kind of co-signer, guarantor, character reference, credit reference, or the like with respect to a debt between a borrower/debtor and a lender/creditor, wherein the funds for the loan can be thought to flow through G(V,E) from l to b through i. It should be appreciated that any number of intermediaries may exist between the borrower/debtor and the lender/creditor. The significance of these intermediaries is described in detail herein and elsewhere, and will be appreciated from the present disclosure.

Each edge 148 may be associated with a flow function 150 ƒ: E→R. For each any every edge (u,v) in E, the flow function 150 may return a real value that specifies or is associated with a credit limit (or the like) of the receiver that is associated with v as granted by the grantor that is associated with u. In embodiments, the real value may be associated with a term, condition, or the like and may be associated with a financial trust relationship between u and v.

For example and without limitation, ƒ(u,v) may denote the value of a credit limit along the edge (u,v); ƒ(u,v) may denote the remaining credit available along the edge (u,v); ƒ(u,v) may denote a maximum value of up to which the grantor will guarantee repayment of a loan that is made to the receiver; and so on. Many other examples will be appreciated and all such examples are within the scope of the present disclosure.

Each edge 148 may be associated with a weight function 128 w: E→R. For each and every edge 148 (u,v) in E, the weight function 128 may return a real value that is equal to or associated with a cost, which may be associated with using the financial trust relationship between the grantor that is associated with u and receiver that is associated with v. So, for example and without limitation, w(u,v) may denote the cost of instantiating a debt-repayment guarantee in which the grantor guarantees partial or full repayment of a debt that is owed by the receiver. The weight function 128 w may comprise an upfront fee, a one-time fee, an ongoing fee, an interest rate, or any and all other fees that may or may not be associated with the flow function 150. In embodiments, w(u,v) may encompass a constant for all values of b and l. Alternatively or additionally, in embodiments, w(u,v) may encompass a component that is a function of a distance or degree of separation, measured in number of vertices 124, between b and l, b and i, i and l, and so on. In embodiments, the fee may be collected from a borrower/debtor that is associated with vertex 124 b and distributed to an intermediary that is associated with vertex 124 i, a lender/creditor that is associated with l, an operator of the sociofinancial facility 100, and so on.

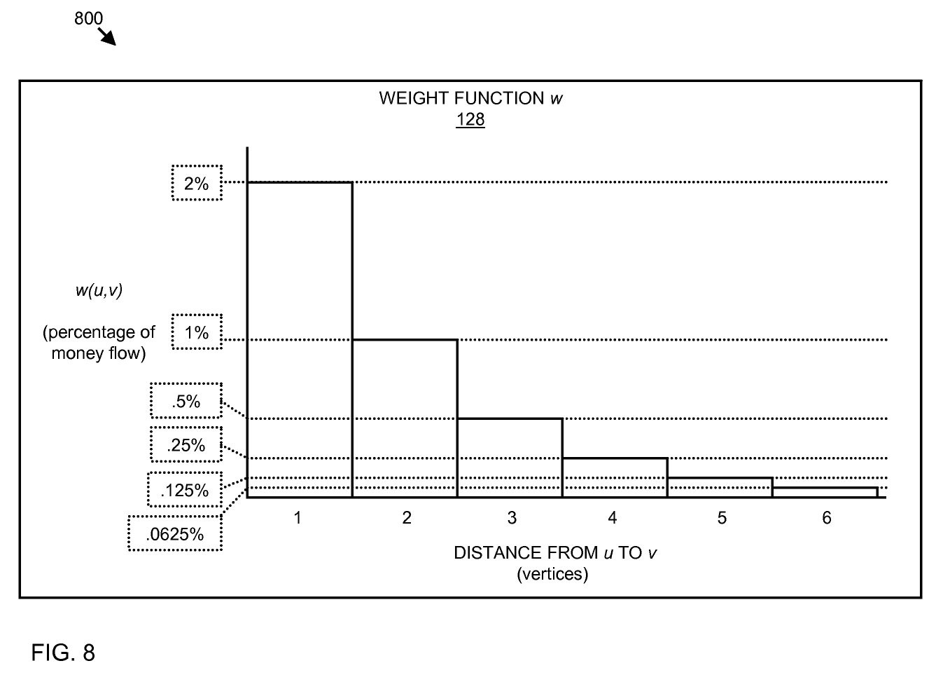

Referring to FIG. 8, an embodiment 800 of the weight function 128 w(u,v) is provided for the purpose of illustration and not limitation. In this embodiment 800, the weight function 128 is a function of the distance or degree of separation between u and v. In applications of the weight function 128, the vertex u may be associated with a lender/creditor or intermediary and the vertex v may be associated with a borrower/debtor or intermediary. According to the present embodiment 800, if u and v are connected by an edge 148 (u,v) in E, then the distance or degree of separation between u and v is one and w(u,v) equals 2%. If there does not exist an edge 148 (u,v) in E but there do exist edges 148 (u,i) and (i,v) in E, then the distance or degree of separation between u and v is two and w(u,v) equals 1%. The illustration also shows values of w(u,v) for distances or degrees of separation of three, four, five, and six. In this embodiment 800, the value of w(u,v) may decline exponentially as a function of the distance or degree of separation between u and v. Many other embodiments of w(u,v) will be appreciated and all such embodiments are within the scope of the present disclosure.

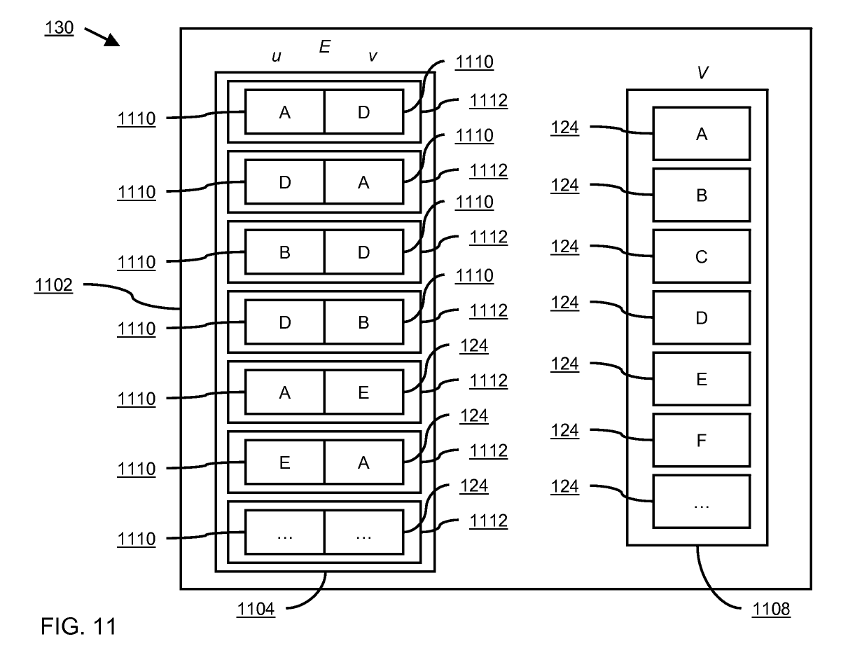

Referring now to FIG. 11, the operational data 130 may, without limitation, comprise an encoding of E, V, G, or the like. The operational data 130 may be encoded in a database 1102 that comprise a two-column table 1104 and a one-column table 1108.

Each row in the two-column table 1104 may encode an edge 148 and so each row may comprise encodings a u vector 124 and a v vector 124. As the depiction of the two-column table 1104 shows, the u vectors 124 may be arranged in one column and the v vectors 124 may be arranged in the other column. The entire two-column table 1104 may comprise an embodiment of E.

Each entry in the one-column table 1108 may encode a vertex 124 in V and the entire one-column table 1108 may comprise an embodiment of V.

It will be appreciated that, when taken together, the vertices V and the edges E may define the graph G and so the database 1102 may comprise an embodiment of G. Those of ordinary skill in the art will appreciate other embodiments of E, V, and G involving data structures such as and without limitation linked lists, heaps, stacks, arrays, trees, bitmaps, and so on. All such embodiments of E, V, and G are within the scope of the present disclosure.

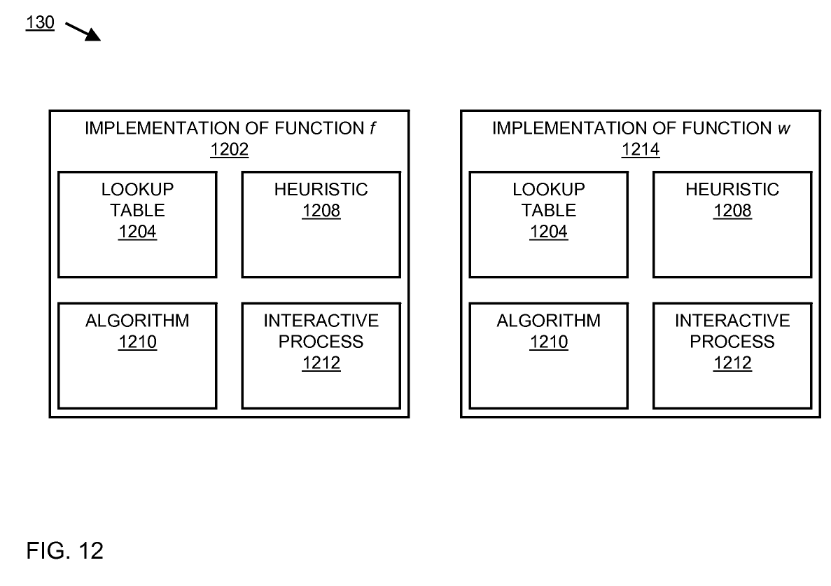

Referring now to FIG. 12, the operational data 130 may additionally or alternatively comprise an implementation 1202 of flow function ƒ 150, an implementation 1214 of weight function 128 w, or the like. Each of the implementations 1202 and 1214 may without limitation comprise a lookup table 1204, a heuristic 1208, an algorithm 1210, an interactive process 1212, and so on. The implementation 1202 of flow function ƒ 150 may return the value of ƒ(x,y) for any and all vertices 124 x and y. The implementation 1214 of weight function w 128 may return the value of w(x,y) for any and all vertices 124 x and y. Many implementations of lookup tables 1208, heuristics 1208, algorithms 1210, and interactive processes 1212 will be appreciated and all such implementations are within the scope of the present disclosure.

In any and all cases, the operational data 130 may be stored in the data storage facility 134 of the sociofinancial computing facility 120. The data storage facility 134 may comprise a hard drive, a tape drive, an optical drive, an electromagnetic memory storage device, a chemical memory storage device, and so on. The data storage facility 134 may be operatively coupled to the sociofinancial computing facility 120 via a bus, network, or the like.

Throughout the present disclosure there are references to various kinds of signals that may be communicated for certain purposes and/or in certain situations. Embodiments of these signals may consist of any and all types of electromagnetic signal including without limitation an electronic, magnetic, photonic, or quantum transmission over a wire, through a fiber-optic cable, across free space, and so on. Embodiments of these signals may consist of any and all types of data transmission including without limitation the transmission of data from one element of the present invention to another element of the present invention via the network 102. For example and without limitation, any and all of the following elements of the present invention may communicate signals between one another via the network 102: credit reporting facility 138, client 104, traditional lending facility 152, verification facility 154, bulk graph data source 144, financial transaction facility 122, sociofinancial computing facility 120, and so on. Embodiments of the signals may, without limitation, comprise a bit; a byte; an instance of a data structure; a data packet; a file; a stream; an XML file; an HTML file; an email message; a text message; a voice message; a multimedia message; video message; instant message; a digital message delivered via a drop box, inbox, queue, or any and all other message-passing protocols or techniques; an animation involving an avatar; and so on. In embodiments, signals may be communicated between the data storage facility 134 and the data storage facility 134.

From time to time, an entity may register itself with the sociofinancial facility 100 so that it may then or later receive services that depend upon or are associated with the sociofinancial facility 100 and the financial trust relationships therein encoded. In embodiments, these services may be associated with lending, borrowing, or actions related thereto such as and without limitation guaranteeing debts, co-signing on loans, and so on. In any case, when an entity registers with the sociofinancial facility 100, a vertex 124 in the sociofinancial graph 108 may be created for and/or associated with the entity. With that done, it may then be possible to encode financial trust relationships between the entity and other entities by creating edges 148 between the entity's vertex 124 and other vertices 124 that are associated with the other entities. The entity may register itself with the sociofinancial facility 100 in accordance with the registration process 110 or any and all other suitable processes.

For example and without limitation, a person may apply for a credit card. The credit card issuer may approve a $1,000 line of credit for the person and, at the same time, suggest to the person that he could increase his line of credit by registering with a website and inviting his friends to register as well. When the user registers at the website, he is asked to provide names and email addresses of friends who may be willing to express some level of financial trust in him. The website may even interface with his personal address book or social network account to automatically load names and email addresses of friends for his consideration. The person enters and/or selects friends to invite via a web form. The website then transmit email invitations to the selected friends. Some of the friends respond by visiting the website and registering (or logging in, if they are already registered). The website informs them that they could collect fees or other considerations in exchange for expressing their financial trust in the person. Some of the friends who have registered and/or logged in decide that they are willing to express their financial trust by specifying how much debt they would commit to repay if the person were to default on such a debt. The friends are then encouraged to invite their friends to register, to express financial trust, to apply for credit via the website, and so on. The friends of the person are themselves encouraged to apply for credit via the website. From time to time, the person may receive an email message from the website that informs him of his new, increased credit limit. The email message explains that the new credit limit is in part a function of the financial trust that his friends have expressed in him via the website. The person may use his credit card subject to this credit limit. As he uses his credit card, some or all of the friends who expressed financial trust in him may receive a fee or other consideration in exchange for allowing their financial trust in the person to be utilized. In other words, by accepting the fee or consideration, the friends become obligated to repay part or all of the person's credit card debt if the person defaults.

For example and without limitation, a person may apply for a mortgage with a bank and be denied. The bank may suggest to the person that he could increase his chances of getting the loan by registering with a website and inviting his friends to register as well. When the user registers at the website, he is asked to provide information about the property that his wants to buy in addition to the names and email addresses of friends who may be willing to express some level of financial trust in him. The website may interface with a real estate valuation tool, the multiple listing service, a registry of deeds, or the like to obtain information (prices, pictures, neighborhood information, maps, encumbrances, and so on) that relate to the real estate. The website then transmits email invitations to the friends. The email contains some information about the property and a hyperlink to the website. Some of the friends respond by visiting the website and registering (or logging in, if they are already registered). The website informs them that they could receive frequent flier miles and be entered into a drawing to win $1,000,000 in exchange for expressing their financial trust in the person's ability to repay the mortgage. Some of the friends who have registered and/or logged in decide that they are willing to express their financial trust by specifying how much debt they would commit to repay if the person were to default on the mortgage. The friends are then encouraged to invite their friends to register, to express their financial trust, to apply for credit via the website, and so on. The friends of the person are themselves encouraged to apply for credit via the website. From time to time, the person may receive an email update from the website that informs him of his progress toward getting his mortgage approved. The email message explains how and to what extent he is being helped by the financial trust that his friends have expressed in him via the website. An illustration of a thermometer in the email depicts how close the person is to reaching his goal of mortgage approval. At some point, enough financial trust is expressed in the person that his mortgage is approved. When he takes out the mortgage, some or all of the friends who expressed financial trust in him receive the promised frequent flier miles and are entered into the drawing for $1,000,000. These miles and the drawing entry are provided to the friends in exchange for allowing their financial trust in the person to be utilized. In other words, by accepting the miles and the entry in the drawing, the friends become obligated to repay part or all of the person's credit card debt if the person defaults.

For example and without limitation, a person who is a member of a social network may read a blog post explaining how he can be rewarded when his friends borrow money. The post tells him that he can load an application into his social network account that allows him to express financial trust in his friends. The post goes on to explain that he will receive his choice of cash or points in an online game when his friends rely on that financial trust to receive credit. The person logs into his social network account and loads the application. The application retrieves a list of his friends in the social network and allows him to pick the friends to whom he wants to extend financial trust. The application informs him that, because he is new to the application, the amount of credit that he can extend to his friends is limited to $200. The application tells him that he can increase this credit by allowing the application to pull his credit score and other financial information. He agrees to allow this. The application prompts him for his social security number and other information that enables the application to retrieve his credit score and other financial information. The application reports back to the person that the credit that he can extend to his friends has been increased to $5,000. At this point, the person expresses his financial trust in some of his friends by entering a credit limit for each of them. These friends receive a message informing them of the financial trust and inviting them to load the application into the social network accounts, if they have not already done so. In response to the message, some of the friends load the application and some of the friends who have already loaded the application go to it. The application informs them of their current credit limit and educates them on how they, too, can be rewarded when their friends borrow money: The friends are encouraged to express financial trust in their friends, and so on. At some point, one of the friends applies for a loan from a bank. The bank reviews this person's credit report as well as the person's credit as calculated by adding up the credit that has been extended to him by friends using the application. The bank discounts the credit that some of his friends have extended to him because the bank believes that those friends are overextended. Based upon both the credit report and the discounted credit from the application, the bank grants a loan to this person on better terms than would have been possible if only the credit report or the discounted credit from the application were considered.

Many other examples will be appreciated and all such examples are within the scope of the present disclosure.

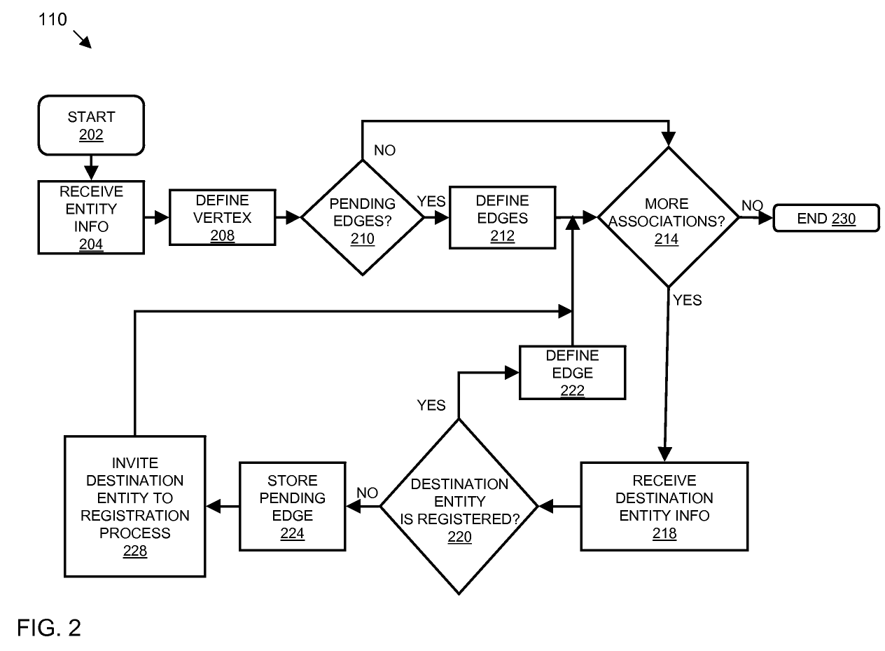

Referring now to FIG. 2, the registration process 110 may be applied to build the entire sociofinancial graph 108 or any and all parts thereof. The logical flow of the registration process 110 may begin at logical block 202 and proceed to logical block RECEIVE ENTITY INFO 204. There, the sociofinancial computing facility 120 may receive information about a first entity. This information may relate to a type of the first entity (e.g. company, individual, and so on), a name, a contact name, a mailing address, an email address, a phone number, a bank account number, a credit card number, a social security number, a date of birth, a date of incorporation, an agreement to terms of a user agreement, and so on. The logical flow may continue to logical block DEFINE VERTEX 208, where the facility 120 may define a vertex u 124 in the graph 108, wherein the vertex 124 is associated with the first entity.

Logical flow may continue to a test at logical block 210, which may determine whether there are any edges 148 that are waiting to be created pending the creation of the vertex u 124. If the result of this test is affirmative, logical flow may proceed to logical block DEFINE EDGES 212 where these edges 148 may be defined, which is to say that the edges 148 may be added to E and the sociofinancial graph 108. In embodiments, a plurality of such waiting-to-be-created edges 148 may have come into being according to an element of the registration process 110 that will be appreciated from the description of logical block 224. From logical block 212, the logical flow may proceed to the test at logical block 214. Similarly, if the result of the test at logical block 210 is negative, then logical flow may continue from there to the test at logical block 214.

The test at logical block 214 may make a determination as to whether the first entity could be associated with a second entity via a new edge 148 in the sociofinancial graph 108. This determination may be useful because the first entity might wish to avail itself of services that depend upon its association with other entities through the sociofinancial graph 108. For example and without limitation, one such service may relate to determining whether the first entity can receive a loan and on what terms that loan can be granted. In this example, each edge 148 between the vertex u 124 and other vertices 124 of other entities may encode and/or be associated with a financial trust relationship that comprises a credit limit or the like. A lender or creditor may depend upon these financial trust relationships in determining whether and on what terms to issue or accept ownership of a loan to the first entity.

In any case, the determination at logical block 214 may be made in any and all numbers of ways, some of which are described herein and elsewhere, some of which will be appreciated, and all of which are within the scope of the present disclosure. For example and without limitation, the determination that is made in logical block 214 may be made by invoking an automatic or interactive process that queries a user, queries a database, queries the bulk graph data source 144 or elements thereof, processes data that is associated with the bulk graph data source 144 or elements thereof, and so on.

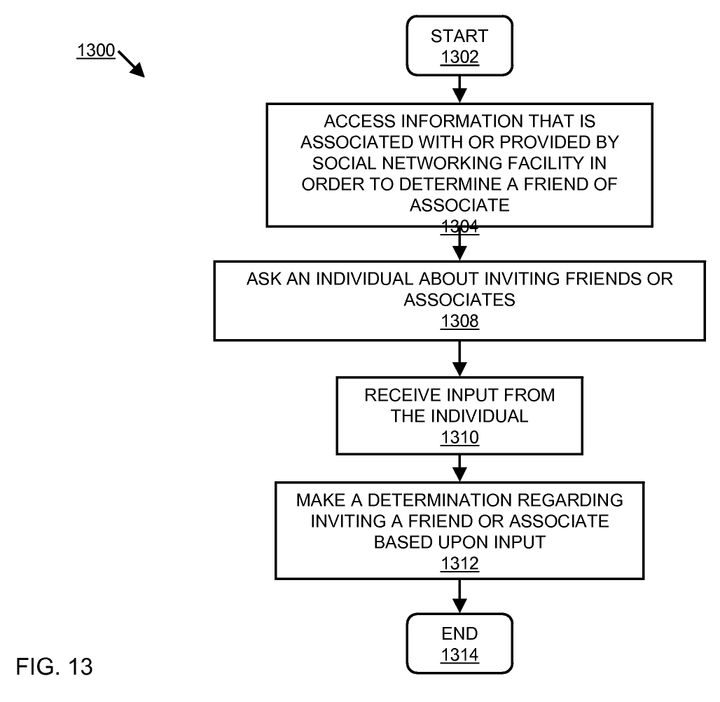

Referring now to FIG. 13, an embodiment of an interactive process 1300 for making the determination at logical block 214 is shown. The process may begin at logical block 1302. Logical flow may continue to logical block 1304 where, in order to determine the second entity, the process accesses information from the social networking facility 140. This information may indicate the second entity that is associated with the first entity. Then, logical flow may continue to logical block 1308 where the process may direct a query toward an individual who is associated with the first entity. The individual may be the first entity itself or a representative of the first entity. The query may serve to ask whether the individual wishes to invite the second entity to express a financial trust relationship toward the first entity. The query may without limitation be embodied as any and all type of signal. Regardless, logical flow may then continue to logical block 1310 where the process receives input from the individual, wherein the input may be a response to the query. The input may be embodied as any and all type of signal. Next, logical flow may continue to logical block 1312 where, based at least in part upon the input, the process makes a determination regarding whether or not the individual wishes to invite the second entity. Finally, the logical flow continues to logical block 1314 where the process ends.

Referring again to FIG. 2, if the determination of the test at logical block 214 is negative, the process 110 may be complete and logical flow may proceed to logical block END 230, where the process 110 ends. However, if the result of the test at logical block 214 is affirmative, then there may be a second entity to which the first entity could be associated. In this case, logical flow may continue to logical block RECEIVE DESTINATION ENTITY INFO 218, where the facility 120 may receive information regarding or associated with the second entity. This information may include a name, a type of entity, and information that is associated with at least one method of contact, such as and without limitation an email address; a phone number; a fax number; a mailing address; an amount of money or other value of ƒ 150 along an edge 148 between the vertex 124 u and a vertex 124 v that may be associated with the second entity; a fee or other value of w 128 along an edge 148 between the vertex 124 u and a vertex 124 v that may be associated with the second entity; and so on. Perhaps depending upon whether the second entity has previously registered with the facility 110, the vertex 124 v may or may not already exist at this point. Therefore, the facility 110 may more or less temporarily store any and all of the information that is received at logical block 218 so that the information may be used later to identify or define the vertex 124 v for association with the second entity.

Logical flow may then proceed to logical block 220, where a test may determine whether the second entity is already registered with or known to sociofinancial computing facility 120. In other words, the test at logical block 220 may determine whether the vertex 124 v already exists. If the result of this test is negative, then logical flow may continue to the STORE PENDING EDGE 224 logical block, where the information that was just gathered at logical block 218 is more or less permanently stored by the sociofinancial computing facility 120. From there, logical flow may continue to logical block INVITE DESTINATION ENTITY TO REGISTRATION PROCESS 228, where the facility 120 may communicate an invitation by way of a signal to the second entity, in accordance with the information that is associated with the at least one method of contact, wherein the invitation encompasses an invitation to participate in the registration process 110. In embodiments, the invitation may encompass an email comprising a URL to a website implementation of the registration process 110. In embodiments the invitation may without limitation comprise an email, a text message, a voice message, a video message, an instant message, an avatar, a hyperlink, a URL, a message delivered via an inbox or online forum, and so on. From there, logical flow may loop back to the test at logical block 214 and continue from there are described hereinabove or elsewhere. However, if the result of the test at logical block 220 is affirmative, then logical flow may proceed from there to the DEFINE EDGE 222 logical block. In this case the second entity is known to and/or registered with the facility 120 and so the sociofinancial graph 108 of the facility 120 may already contain a vertex 124 v that is associated with the second entity. Thus, at this step in the logical flow an edge 148 (u,v) may become defined in E, and the values of ƒ(u,v) 150 and w(u,v) 128 may become defined or calculable according to any and all information including, without limitation, the information that was just gathered at logical block 218. From here, logical flow may proceed back to logical block 214, which is described in detail hereinabove and elsewhere.

During the registration process 110 or at any time thereafter, the first entity may provide information that is associated with an asset that can be attached or from which money can be drawn during a collections process. The asset may comprise a property, a bank account, a paycheck, a credit card, and so on. The information may consist of a book and page number, a bank account number, an employer identifier, a credit card number, and so on. For example and without limitation, if the first entity becomes responsible for repaying a debt then a periodic charge may be made to the credit card, a periodic withdrawal may be made from the bank account, and so on. It will be appreciated that an automatic process of the sociofinancial facility 100 may make the periodic charge.

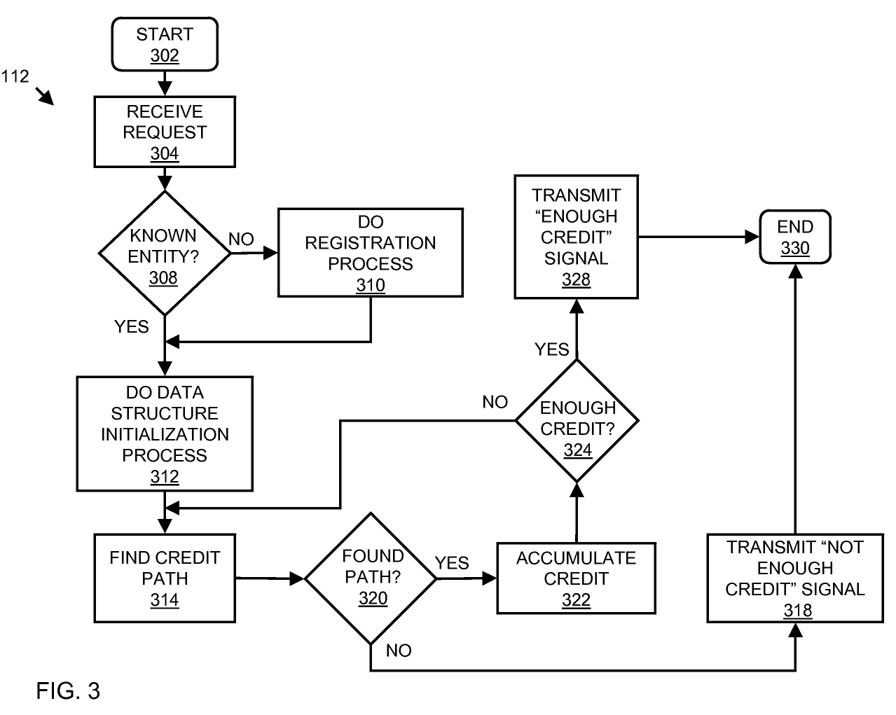

Referring now to FIG. 3, logical flow of the credit calculation process 112 may begin at logical block 302 and proceed to logical block RECEIVE REQUEST 304. Here, the facility 120 may receive a request to calculate whether an entity is associated with at least a certain amount of credit. The entity may be referred to hereinafter as “the credit-seeking entity”. In embodiments, a signal may encompass the request, which may arrive at the facility 120 from the network 102. Logical flow may proceed to the test at logical block 308, which may determine whether the entity is known and/or registered with the facility 120.

If the result of this test is negative, logical flow may proceed to logical block DO REGISTRATION PROCESS 310, where the registration process 110 may be conducted. (The registration process may be herein described with reference to FIG. 2.) After the registration process completes, logical flow may proceed to logical block INITIALIZE DATA STRUCTURES 312. However, if the result of the test at logical block 308 is affirmative then processing flow may proceed directly from logical block 308 to logical block INITIALIZE DATA STRUCTURES 312.

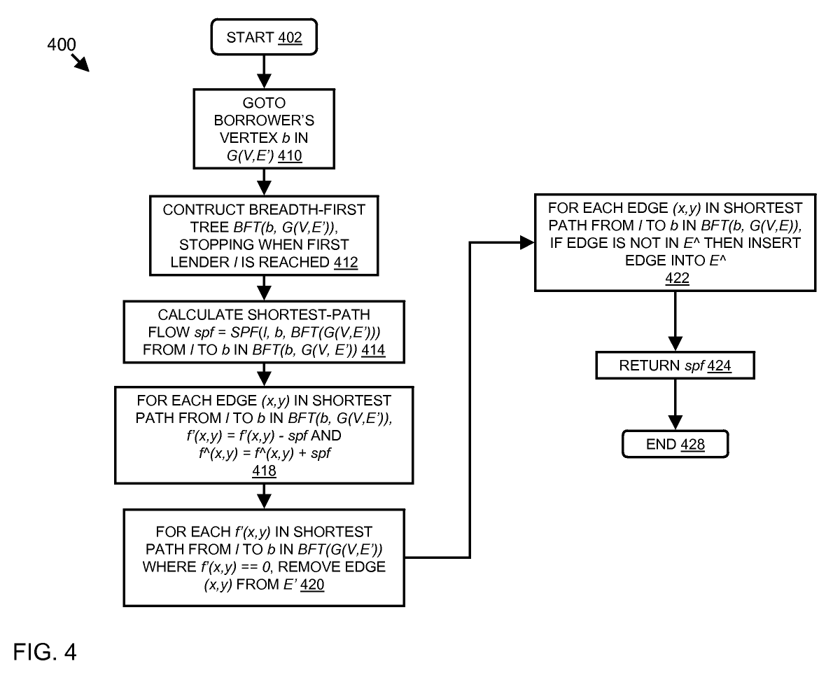

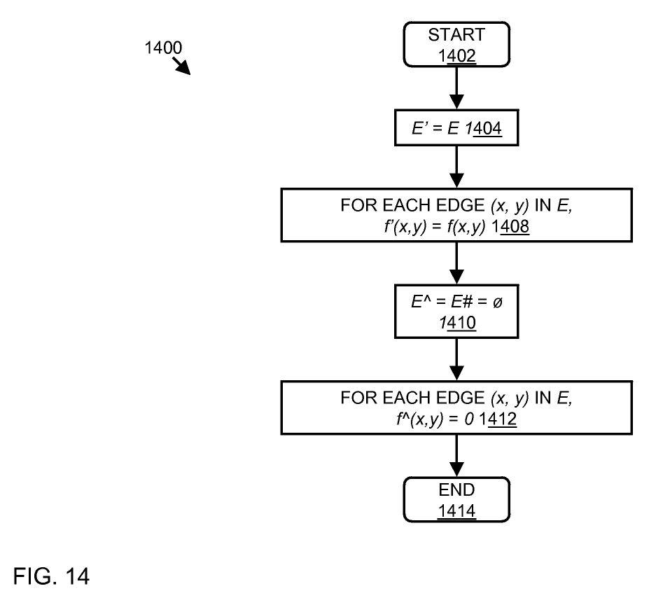

In any case, at logical block 312 a process for initializing data structures may execute. (That process may be described in detail hereinafter with reference to FIG. 14.) Upon the completion of said initialization process, logical flow may continue to logical block FIND CREDIT PATH 314. Here, a path through the sociofinancial graph 108 from a lender to the credit-seeking entity may be found and an associated credit limit may be returned, both according to a procedure that is described hereinafter in detail with reference to FIG. 4 and elsewhere. Once that procedure completes, logical flow may proceed to the test at logical block 320, which may determine whether such a path through the sociofinancial graph 108 was found.

If the result of the test at logical block 320 is negative, then logical flow may continue to logical block TRANSMIT “NOT ENOUGH CREDIT” SIGNAL 318, where the facility 120 may transmit a signal indicating that the credit-seeking entity is not associated with at least the certain amount of credit in the request. (This signal may be referred to herein and elsewhere as the “not-enough-credit signal”.) From there logical flow may proceed to logical block END 330, where the credit calculation process 112 may terminate.

However, if the result of the test at logical block 320 is affirmative, then logical flow may continue to logical block ACCUMULATE FUNDS 322, where the associated credit limit that was returned in logical block 314 may be added to an accumulator that stores the total credit limit that has so far been found in response to the request that was received in logical block 304. Then, logical flow may continue to a test at logical block 324, which may determine whether the accumulator contains an amount that is at least as large as the certain amount of credit in the request. If the result of this test is negative, then logical flow may return back to the FIND CREDIT PATH 314 logical block. However, if the result of the test at 324 is affirmative, then logical flow may continue to logical block TRANSMIT “ENOUGH CREDIT” SIGNAL 328, where there is transmitted a signal indicating that enough credit has been found. (This signal may be referred to herein and elsewhere as the “enough-credit signal”.) Finally, logical flow may continue to logical block END 330, where the credit calculation process 112 terminates.

Examples of systems and methods for finding and using paths through the sociofinancial graph 108 are herein described for the purpose of illustration and not limitation. These systems and methods may utilize temporary data structures that are also described for the purpose of illustration and not limitation. These data structures may encompass a function ƒ′, a function θ̂, a set of edges E′, a set of edges Ê, and a set of edges E#. The function ƒ′ may take as input two vertices 124 that are associated by an edge 148 in E′ and may produce as output a value of the same type as that produced by the flow function 150 ƒ. The function ƒ̂ may take as input two vertices 124 that are associated by an edge 148 in E, E′, Ê, or E# and may produce as output a value of the same type as that produced by the flow function 150 ƒ. Before finding and using the paths, it may be necessary to initialize these data structures.

Referring now to FIG. 14, logical flow of a process 1400 for initializing the data structures may begin at logical block 1402 and continue to logical block 1404. Here, the set of edges E′ may be initialized to be identical to E. Logical flow may continue to logical block 1408 where, for each and every edge 148 in E, the output values of the function ƒ′ are initialized to be to equal those of the flow function 150 ƒ. Then, logical flow may continue to logical block 1410 where Ê and E# are both initialized to be equal to the empty set. From there logical flow may proceed to logical block 1412 where, for each and every edge 148 in E, the output values of the function ƒ̂ are initialized to be zero. Finally, logical flow may continue to logical block 1414 where the process 1400 ends.

Referring now to FIG. 4, logical flow of a process 400 for finding a funding path may begin at logical block 402. From there, logical flow may continue to logical block 410 where the process 400 may begin a search of the graph G(V,E′) starting at a vertex b that is associated with the borrower. Then, logical flow may continue to logical block 412, where a breadth-first tree BFT(b, G(V,E′)) is constructed through G(V,E′) from b to a vertex l using edges that are directed from l to b. The vertex l may be the first vertex associated with a lender that is encountered during the construction of BFT(b, G(V,E′)). Thus, construction of the BFT(b, G(V,E′)) may halt upon reaching l. It will be appreciated by those skilled in the art that the construction of a breadth-first tree through a weighted graph may involve considering weights along the edges in the graph. In particular, the branch of the tree that has the lowest total weight from the root vertex 124 b to the leaf may be the branch that is expanded at each step in the tree's construction. In embodiments, values produced by the weight function 128 w may define these weights. In any case, when construction of the breadth-first tree halts then logical flow may continue to logical block 414 where a shortest-path flow spf may be calculated from l to b through BFT(B, G(V,E′)). The shortest path flow may be determined by finding the smallest value of ƒ′ along the edges 148 in the shortest path. (Recall that ƒ′ of an edge (x,y) may define the credit limit of a financial trust relationship between the entities that are represented by the vertices x and y.) Next, the logical flow may proceed to logical block 418 where, for each edge 148 (x,y) in the shortest path the value of ƒ′(x,y) is set to equal ƒ′(x,y)−spf and the value of ƒ̂(x,y) is set equal to ƒ̂(x,y)+spf. Then, logical flow may continue to logical block 420 where every edge 148 (x,y) in the shortest path for which ƒ′(x,y)=0 is removed from E′. Logical flow may proceed to logical block 422 where every edge 148 (x,y) in the shortest path that is not already in EA is inserted into EA. The logical flow may then go to logical block 424 where the value of spf is returned to the calling process. Finally, logical flow proceeds to logical block 424 where the process 400 ends.

It will be appreciated that there may be cases in which no path exists from l to b through BFT(b, G(V,E′)). In these cases, spf may be undefined and processing that depends upon spf may produce results that are also undefined.

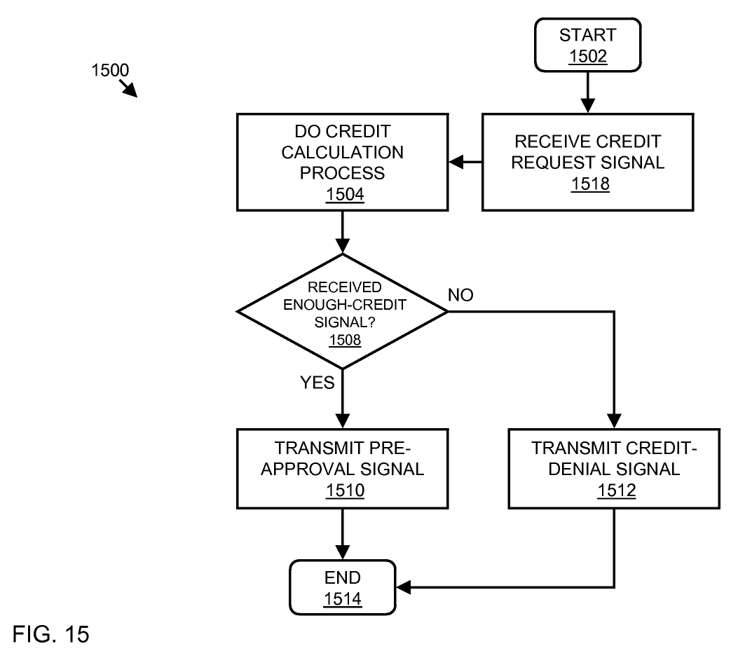

After the completion of the credit calculation process 112 (and assuming that spf is defined), it may be possible to conduct a process for pre-approving a request for credit. Referring now to FIG. 15, logical flow of a process 1500 for pre-approving a lending action may begin at logical block 1502 and proceed to logical block RECEIVE CREDIT REQUEST SIGNAL 1518 where the process receives a signal embodying a request for a certain amount of credit to be extended to a particular entity. As logical flow continues to logical block DO CREDIT CALCULATION PROCESS 1504, this request may be passed as an input parameter to the credit calculation process 112 that is invoked at 1504. Upon return of the credit calculation process 112, logical flow may continue to a test at logical block 1508, which may determine whether the credit calculation process 112 returned the enough-credit signal. If the result of this test is affirmative, then logical flow may proceed to logical block TRANSMIT PRE-APPROVAL SIGNAL 1510 where the process 1500 transmits a pre-approval signal to indicate that at least the certain amount of credit was found to be associated with the particular entity. Otherwise, if the result of the test at 1508 is negative, then logical flow may proceed to logical block TRANSMIT CREDIT-DENIAL SIGNAL 1512 where the process 1500 transmits a credit-denial signal to indicate that the certain amount of credit was not found to be associated with the particular entity. From both logical block 1510 and logical block 1512, logical flow may proceed to logical block 1514 where the process 1500 ends.

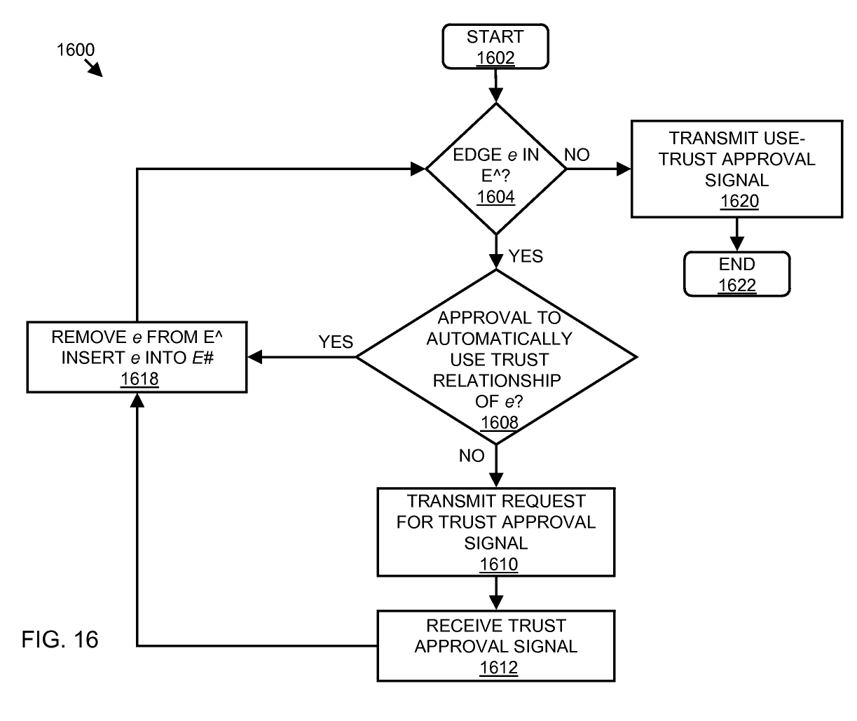

If the process 1500 for pre-approving a request for credit transmits the pre-approval signal, then it may be possible to conduct a process for approving a lending action. Referring now to FIG. 16, logical flow for a process 1600 for approving the use of trust relationships in association with a request for credit begins at logical block 1602 and continues to a test at logical block 1604. This test determines whether or not there exists an edge 148 e in Ê. If the result of this test is negative, then logical flow continues to logical block TRANSMIT USE-TRUST APPROVAL SIGNAL 1620 where the process 1600 transmits a use-trust approval signal to indicate that approval exists to use all of the trust relationships that are associated with the certain amount of credit that was pre-approved in process 1500 of FIG. 15. From there, logical flow continues to logical block END 1622 where the process 1600 ends.

However, if the result of the test at logical block 1604 is affirmative then logical flow may continue to a test at logical block 1608. The test at logical block 1608 may make a determination as to whether there exists approval to automatically use the trust relationship that is associated with the edge 148 e.

In embodiments, the grantor of the financial trust relationship may from time to time indicate that the financial trust relationship can be automatically used, can be used only with explicit approval, cannot be used, and so on. These indications may be received at the sociofinancial computing facility 120 in the form of a signal; encoded by the sociofinancial computing facility 120; and then stored in the data storage facility 134. The test at logical block 1608 may retrieve and/or rely upon these encoded indications when making the determination.

If the result of the test at logical block 1608 is affirmative, logical flow may proceed to logical block 1618 where the edge 148 e is removed from the set EA and inserted into the set E#. From there, logical flow may return to logical block 1604. However, if the result of the test at logical block 1608 is negative then logical flow may proceed to logical block TRANSMIT REQUEST FOR TRUST APPROVAL SIGNAL 1610 where the process 1600 may transmit a signal that requests approval to use the trust relationship that is associated with edge 148 e. From there, logical flow may proceed to logical block RECEIVE TRUST APPROVAL SIGNAL 1612 where the process 1600 receives a signal indicating that there now exists approval to use the trust relationship. Then, logical flow may continue to logical block 1618.

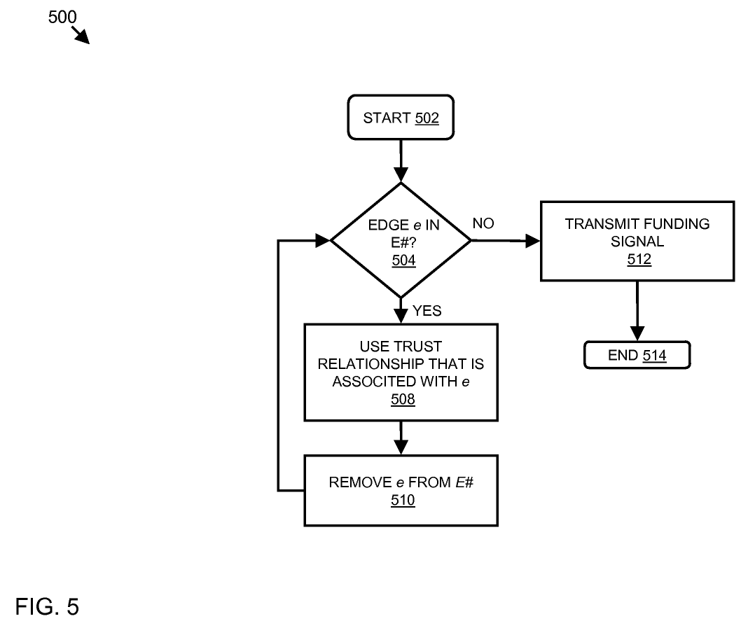

After completion of the process 1600 for approving the lending action, it may possible to conduct a process for using trust relationships in associated with a lending action. Referring now to FIG. 5, a process 500 for using trust relationships in association with a lending action may begin at logical block 502 and continue to a test at logical block 504 that determines whether there exists an edge 148 e in Ê. If the result of this test is negative, logical flow may proceed to logical block TRANSMIT FUNDING SIGNAL 512 where the process 500 transmits a funding signal to indicate that the financial trust relationships that are associated with the lending action have been used and so it is an appropriate time to fund the lending action. From there, the logical flow may proceed to logical block 514 where the process 500 ends.

However, if the result of the test at logical block 504 is positive then logical flow may proceed to logical block USE TRUST RELATIONSHIP THAT IS ASSOCIATED WITH e 508. Here the grantor of the financial trust relationship that is associated with edge 148 e may receive some form of compensation or consideration in exchange for accepting some kind of co-signer, debtor, or guarantor role with respect to the lending action. In embodiments, this compensation or consideration may or may not be associated with the value of the weight function 128 w for the edge 148 e. In embodiments, by accepting the compensation or consideration the grantor may be legally bound to its role as co-signer, debtor, guarantor, or the like. From logical block 508, logical flow may proceed to logical block 510 where the edge 148 e is removed from E#. Logical flow may continue from there to logical block 504.

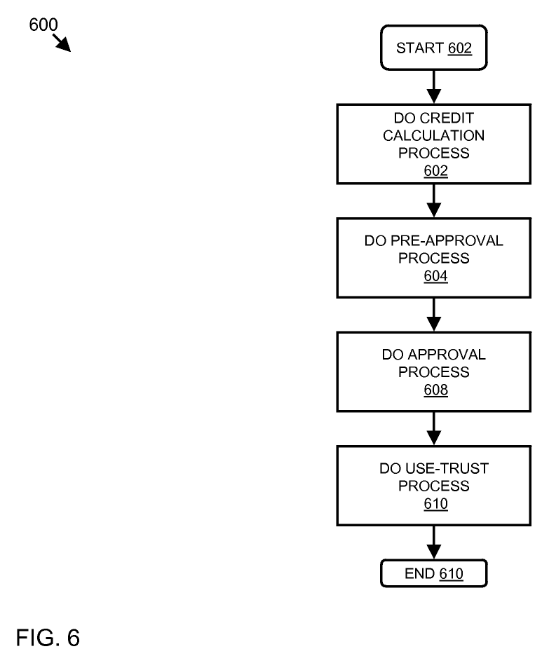

Referring now to FIG. 6, a process 600 for approving a lending action may begin at logical block 602 and continue to logical block DO CREDIT CALCULATION PROCESS 602. Here, the credit calculation process 300 may be invoked with respect to a particular entity. If the credit calculation process 300 transmits the enough-credit signal, logical flow may proceed to logical block DO PRE-APPROVAL PROCESS 604. Here, the process 1500 for pre-approving a request for credit may be invoked with respect to the particular entity and an amount of credit. If the process 1500 transmits the pre-approval signal, logical flow may proceed to logical block DO APPROVAL PROCESS 608. Here, the process 1600 for approving the use of trust relationships in association a request for credit may be invoked with respect to the particular entity and the amount of credit. If the process 1600 transmits the use-trust approval signal, logical flow may proceed to logical block DO USE-TRUST PROCESS 610. Here, the process 500 for using trust relationships in association with a request for credit may be invoked with respect to the particular entity and the amount of credit. If the process 500 transmits the funding signal, processing flow may continue to logical block 610 where the process 600 for approving a lending action ends.

In embodiments, any and all of the signals that are transmitted by the processes that are invoked by process 600 may be communicated, transmitted, retransmitted, relayed, returned, or the like to any and all of the elements or processes of the present invention. For example and without limitation, the funding signal may be transmitted to the traditional lending facility 152, which in response to the funding signal may fund a loan to the particular entity. For another example and also without limitation, the funding signal may be transmitted to the credit reporting facility 138, which in response to the funding signal may modify a credit score of the particular entity. For another example and also without limitation, the funding signal may be transmitted to the bulk graph data source 144, which in response to the funding signal may modify some aspect of itself or its constituent elements. Many other examples will be appreciated and all such examples are within the scope of the present disclosure.

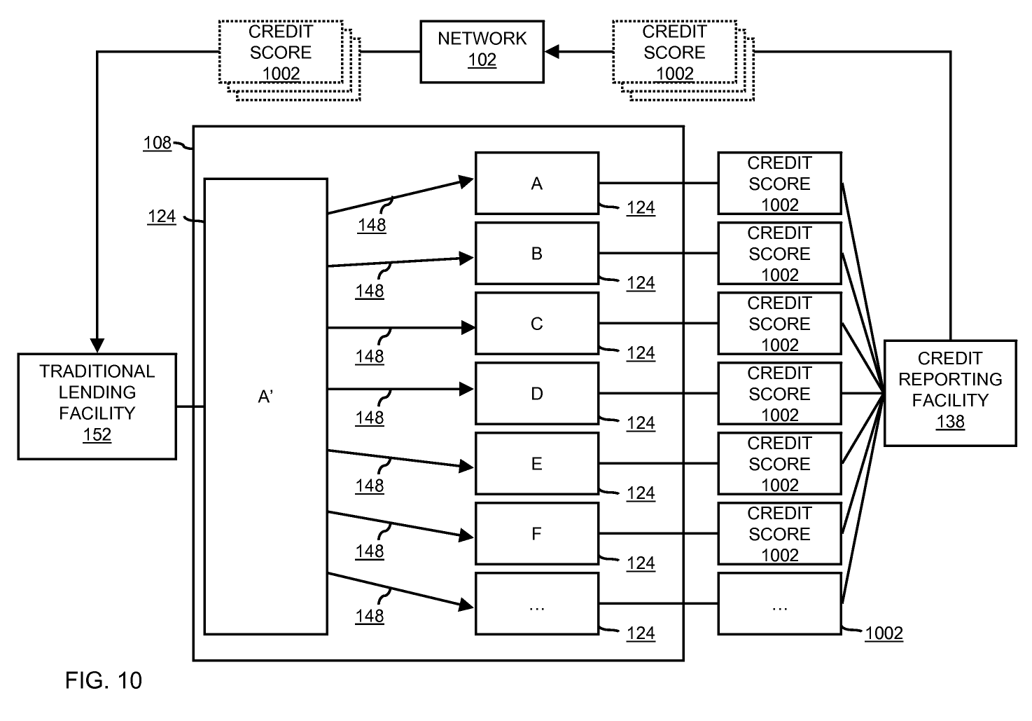

Referring now to FIG. 10, in embodiments of the present invention a traditional lending facility 152 may use credit scores 1002 in determining whether to express direct financial trust relationships toward other entities via the sociofinancial graph 108. The traditional lending facility 152 may receive the credit scores 1002 from the credit reporting facility 138 via the network 102. The credit scores may be associated with the other entities, which may be represented as vertices 124 in the sociofinancial graph 108. In the present depiction all of the vertices 124, except the A′ vertex 124, are intended to represent the other entities. As depicted and as will be appreciated, these financial trust relationships may be encoded as edges 148. It will be further appreciated that, in embodiments, the other entities may have financial trust relationships between themselves that are also encoded as edges 148. Thus, the sociofinancial graph 108 may simultaneously represent both the financial trust relationships between the other entities and the financial trust relationships between the traditional lending facility 152 and the other entities.

It will be appreciated that the financial trust relationships from the traditional lending facility 152 to the other entities may be analogous or identical to lines of credit that extend from the traditional lending facility 152 to the other entities. Thus, systems and methods that utilize the sociofinancial graph 108 may enhance traditional lending practices by allowing the traditional lending facility 152 to use, at its option, the financial trust relationships that exist between the other entities. As is described herein and elsewhere, using these financial trust relationships may be associated with a cost or fee that is paid to the entities whose financial trust is used in association with a lending action. Benefits of using these financial trust relationships may, without limitation, include reducing risk to the traditional lending facility 152 and increasing the credit that the traditional lending facility 152 may extend to the entities.

Various techniques (such as and without limitation algorithms, heuristics, and the like) exist for calculating flows through a flow network. These techniques may comprise exact or approximate solutions the maximum flow problem, the multi-commodity flow problem, the minimum cost flow problem, the circulation problem, and the like. In the art, any number of these techniques may be knows as “graph algorithms”. It will be appreciated that these techniques may be applied to the sociofinancial graph 108 in order to produce results that are associated with making lending decisions. All such techniques as would be clear to one of ordinary skill in the art are intended to fall within the scope of this disclosure.

All of the elements of the sociofinancial facility may be depicted throughout the figures with respect to logical boundaries between the elements. According to software or hardware engineering practices, the modules that are depicted may in fact be implemented as individual modules. However, the modules may also be implemented in a more monolithic fashion, with logical boundaries not so clearly defined in the source code, object code, hardware logic, or hardware modules that implement the modules. All such implementations are within the scope of the present disclosure.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

It will be appreciated that the above processes, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a camera system and/or a computer in a number of ways, or all of the functionality may be integrated into a dedicated, standalone image capture device or other hardware. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
encoding a plurality of trust relationships as a graph including a plurality of vertices and a plurality of edges, each one of the vertices representing an entity and each one of the edges representing a discrete trust relationship, at least one of the discrete trust relationships including a dollar amount that an associated entity will guarantee; and
evaluating the graph to obtain a lending decision.

2. The method of claim 1 wherein one of the plurality of vertices represents a lender.

3. The method of claim 2, wherein the lender is selected from the group consisting of a financial institution, a credit card provider, and an individual.

4. The method of claim 1 wherein one of the plurality of vertices represents a borrower.

5. The method of claim 1 further comprising issuing a loan based upon the lending decision, the loan including an explicit guarantee for the dollar amount by the associated entity.

6. The method of claim 1 wherein one or more of the entities has an identity authenticated within the graph by a trusted third party.

7. The method of claim 1 further comprising:
receiving a modification to one of the discrete trust relationships from one of the entities;
authenticating an identity of the one of the entities; and
entering the modification into the graph.

8. The method of claim 7 further comprising re-evaluating the lending decision based upon the modification.

9. The method of claim 1, wherein the graph is a weighted flow network.

10. The method of claim 1, wherein the graph is a flow network.

11. The method of claim 1, wherein the graph is selected from the group consisting of a weighed directed graph, a directed graph, and an undirected graph.

12. The method of claim 1, wherein the graph is a flow network with gains.

13. A computer program product comprising computer executable code embodied in a computer readable medium that, when executing on one or more computing devices, performs the steps of:
encoding a plurality of trust relationships as a graph including a plurality of vertices and a plurality of edges, each one of the vertices representing an entity and each one of the edges representing a discrete trust relationship, at least one of the discrete trust relationships including a dollar amount that an associated entity will guarantee; and
evaluating the graph to obtain a lending decision.

14. The computer program product of claim 13 wherein one of the plurality of vertices represents a lender.

15. The computer program product of claim 14 wherein the lender is selected from the group consisting of a financial institution, a credit card provider, and an individual.

16. The computer program product of claim 13 wherein one of the plurality of vertices represents a borrower.

17. The computer program product of claim 13 further comprising computer executable code that performs the step of issuing a loan based upon the lending decision, the loan including an explicit guarantee for the dollar amount by the associated entity.

18. The computer program product of claim 13 wherein one or more of the entities has an identity authenticated within the graph by a trusted third party.

19. The computer program product of claim 13 further comprising computer executable code that performs the following steps:
receiving a modification to one of the discrete trust relationships from one of the entities;
authenticating an identity of the one of the entities; and
entering the modification into the graph.

20. The computer program product of claim 19 further comprising computer executable code that performs the step of re-evaluating the lending decision based upon the modification.

21. The computer program product of claim 13, wherein the graph is a weighted flow network.

22. The computer program product of claim 13, wherein the graph is a flow network.

23. The computer program product of claim 13, wherein the graph is selected from the group consisting of a weighted directed graph, a directed graph, and an undirected graph.

24. The computer program product of claim 13, wherein the graph is a flow network with gains.
